(19) United States
(12) Patent Application Publication
(10) Pub. No.: US 2025/0137296 A1
(43) Pub. Date: May 1, 2025

(54) CONVENIENT GUIDE RAIL INTERLOCKING MECHANISM

(71) Applicant: Qingyuan Saca Precision Manufacturing Co.,Ltd., Qingyuan (CN)

(72) Inventors: HUAIKE XU, Qingyuan (CN); KAICHENG LUN, Qingyuan (CN); GENGXI CAI, Qingyuan (CN)

(21) Appl. No.: 18/918,465

(22) Filed: Oct. 17, 2024

(30) Foreign Application Priority Data
Oct. 31, 2023 (CN) 202311439057.7

(51) Int. Cl. E05B 65/463; A47B 88/49; A47B 88/50

(52) U.S. Cl. CPC E05B 65/463; A47B 88/50; A47B 88/49

(57) ABSTRACT

A convenient guide rail interlocking mechanism is provided, which includes an interlocking mechanism, the interlocking mechanism includes a front-end interlocking assembly, the front-end interlocking assembly includes a front lock fixing seat, a front lock insertion block, a front lock clamp block, and a linkage rod. The front lock fixing seat is provided at a front end of an outer rail, and provided with a guide recess. Two ends of the linkage rod are respectively provided with the front lock insertion block, which is respectively inserted into the corresponding outer rail. The front lock insertion block is slid downward on the guide recess under its own weight, and under a linkage action of the linkage rod, the front lock insertion block is driven to move downward and locked on the corresponding outer rail. The front lock clamp block is provided at a front end of an inner rail.

### CROSS-REFERENCE TO RELATED APPLICATIONS

This application claims priority to Chinese Patent Application No. 202311439057.7, filed on Oct. 31, 2023, which is hereby incorporated by reference in its entirety.

### TECHNICAL FIELD

The present disclosure relates to the field of drawer rail technologies, and in particular, to a convenient guide rail interlocking mechanism.

### BACKGROUND

CN 202220775836.9 discloses a drawer guide rail with self-locking interlocking function. The drawer guide rail includes a cabinet, at least three sets of drawers distributed vertically on the cabinet, and a guide rail assembly on each set of the drawers. The guide rail assembly includes an inner rail that drives the drawer to slide, an outer rail fixed on the cabinet, and a middle rail that connects the inner rail and the outer rail. The drawer is provided with an interlocking device with self-locking and interlocking functions. The interlocking device includes a guide rail self-locking component and a drawer interlocking component. Under a structural cooperation of the guide rail self-locking component and the drawer interlocking component, the drawer can be automatically closed under an elastic action of the guide rail self-locking component during a process of closing the drawer, so to realize the self-locking function of the guide rail assembly; during a process of a plurality of drawers being closed in the cabinet, only one drawer can be pulled out at one time under an interlocking action of the drawer interlocking component, thereby achieving the interlocking function between the guide rail components.

However, the rail interlocking devices of the above structure are designed at the tail end of the rail, which has the following shortcomings in a practical application: 1. It is inconvenient to installation.

2. The length accuracy of an interlocking connection rod is required to be high. Sometimes, when a user installs the guide rail with a large distance tolerance, the connecting rod becomes too short and affects the interlocking effect.

3. Some individual customers believe that the interlock function is unreliable, and when a pulling force is suddenly increased, the interlock mechanism may fail due to a deformation of a slider.

4. If there are 5 drawers and the interlocking function is not obvious, sometime, two drawers may be opened at the same time.

### SUMMARY

The purpose of the present disclosure is to overcome the shortcomings of the prior art and provide a convenient guide rail interlocking mechanism that is easy to install, has stable and reliable structural, which can improve an interlocking effect, thereby ensuring that only one drawer can be pulled out at one time under an interlocking action, and having safe use.

The purposes of the present disclosure is achieved as follows: a convenient guide rail interlocking mechanism, including an interlocking mechanism configured to lock or unlock a plurality sets of guide rail components, where the guide rail components include an inner rail, a middle rail, and an outer rail that are slidably connected; an inner pearl nest component is slidably provided between the middle rail and the inner rail, an outer bead nest assembly is slidably provided between the middle rail and the outer rail, where the interlocking mechanism includes a front-end interlocking assembly, the front-end interlocking assembly includes a front lock fixing seat, a front lock insertion block, a front lock clamp block, and a linkage rod; the front lock fixing seat is provided at a front end of the outer rail; the front lock fixing seat is provided with a guide recess; two ends of the linkage rod are respectively provided with the front lock insertion block, and the front lock insertion blocks are respectively inserted into a corresponding outer rail; the front lock insertion block is slid downwards on the guide recess under its own weight, and under a linkage action of the linkage rod, the front lock insertion block is driven to move downwards and locked on the corresponding outer rail; the front lock clamp block is provided at a front end of the inner rail, and the front lock clamp block pushes the front lock insertion block to move upwards when the inner rail is slid outwards, thereby causing the front lock insertion block to be opened and unlocked on the outer rail, and at the same time, under the linkage action of the linkage rod, the front lock insertion block is driven to be locked on the corresponding outer rail.

In some embodiments of the present disclosure, the outer rail is provided with a connection guide slot and a plug-in slot; upper and lower sides of the outer rail are respectively provided with the plug-in slot, and the front lock insertion block is inserted into the outer rail through the plug-in slot; the front lock fixing seat is capable of being disassembled on an outside of the outer rail through a connector, so that the guide recess is communicated with the connection guide slot and forms a front-end interlocking groove for the front lock insertion block to be locked or unlocked on the outer rail.

In some embodiments of the present disclosure, the front lock insertion block includes a front locking protrusion that slides in the guide recess and be locked or unlocked at the front end of the outer rail; the front locking protrusion is provided with a limit groove so as to prevent the front locking protrusion from being detached from the outer rail.

In some embodiments of the present disclosure, an outer end of the front lock insertion block is provided with a clamp slot for the linkage rod to be inserted, an inner end of the front lock insertion block is provided with an extended linkage push rod; the front lock insertion block is capable of being inserted into the outer rail, so that extended linkage push rods between the front lock insertion blocks are connected or separated in a staggered manner.

In some embodiments of the present disclosure, the front-end interlocking assembly further includes a linkage self-locking component, which includes a self-locking front stopper and a self-locking rear stopper rubber; the self-locking front stopper is provided at a front end of the middle rail, and the self-locking front stopper is connected or separated from the inner rail when the guide rail components is opened or closed; the self-locking rear stopper rubber is provided at a tail end of the outer rail, and the inner rail is provided with a closing position for elastic clamping with the self-locking rear stopper rubber when the inner rail is closed.

In some embodiments of the present disclosure, a tail end of the outer rail is provided with a positioning buckle, the self-locking rear stopper rubber is capable of being fastened to the positioning buckle, an outer edge of the self-locking rear stopper rubber is provided with an elastic arc-shaped outer edge that is elastically clamped with the closing position.

In some embodiments of the present disclosure, a tail end of the middle rail is provided with a rear stopper rubber for stopping the inner pearl nest component from moving backward or synchronously moving forward with the inner rail; the rear stopper rubber is clamped in the closing position or separated from the closing position when the middle rail is moved; an internal limit movement space for a movement of the inner pearl nest component is formed between the rear stopper rubber and the self-locking front stopper.

In some embodiments of the present disclosure, two sides of a front end of the outer rail are respectively provided with a front stop point; an outer limit movement space for a movement of the outer bead nest assembly is formed between the front stop point and the self-locking rear stopper rubber.

In some embodiments of the present disclosure, a tail end of the inner rail is provided with a rubber stopper configured to push the inner pearl nest component to move; a shortest distance between the rubber stopper and the self-locking front stopper is a pull-out distance of the inner rail relative to the middle rail.

The advantages of the present disclosure are as following:
1) through a structural cooperation of the front lock fixing seat, the front lock insertion block, the front lock clamp block, and the linkage rod of the front-end interlocking assembly, not only can only one drawer be pulled out at one time under an interlocking effect, so that the interlocking function between the guide rail components is realized, and the front-end assembly is provided at the front end of the guide rail assembly so as to solve a problem of assembly difficulty, thereby improve structural reliability, and ensuring the interlocking effect.
2) due to the front-end assembly of the interlocking assembly, the inner and outer bead nest assemblies are ensured to roll freely between the inner rail, middle rail, and outer rail, which facilitates the assembly and ensuring the stability when the guide rail components are operated.
3) when the linkage self-locking component of the present disclosure is used, the self-locking front stopper of the self-locking component is cooperated with the closing position so as to achieve self-locking function for each guide rail component, thereby ensuring the quality of the product during use.

### BRIEF DESCRIPTION OF DRAWINGS

FIG. 1 is a schematic structural diagram of an embodiment of the present disclosure.

FIG. 2 is a schematic structural diagram in another angle of the embodiment of the present disclosure.

FIG. 3 is a schematic diagram of a relationship between an outer rail and a front lock fixing seat in the embodiment of the present disclosure.

FIG. 4 is an exploded view of the embodiment of the present disclosure.

FIG. 5 is a use state diagram of the embodiment of the present disclosure.

### DESCRIPTION OF EMBODIMENTS

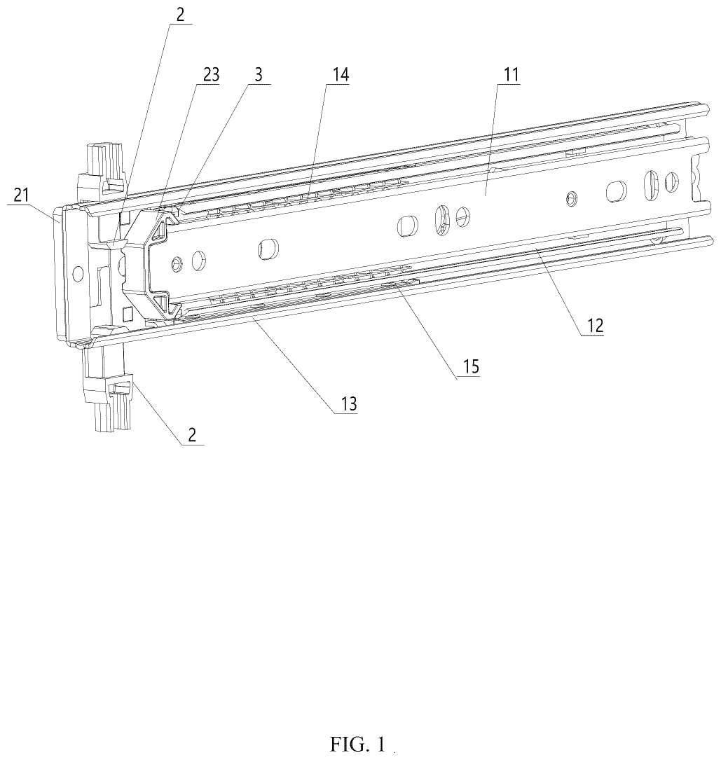

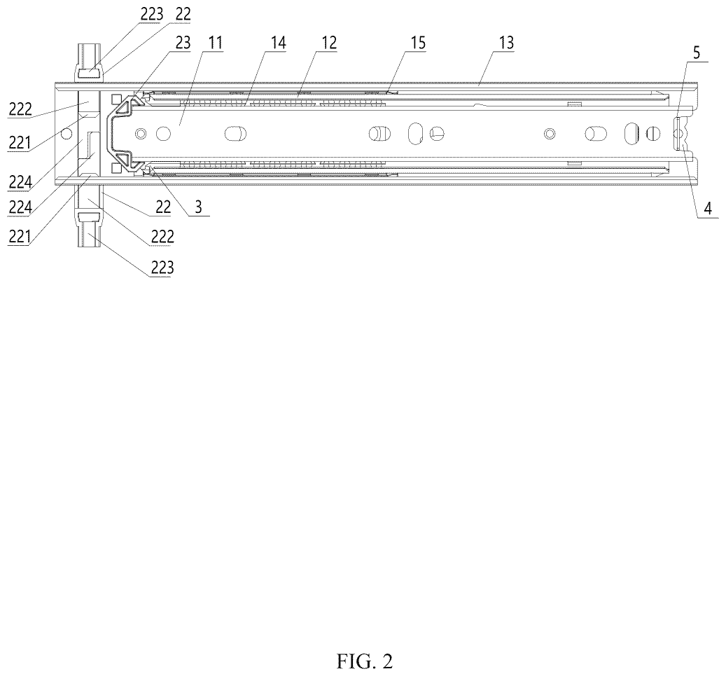

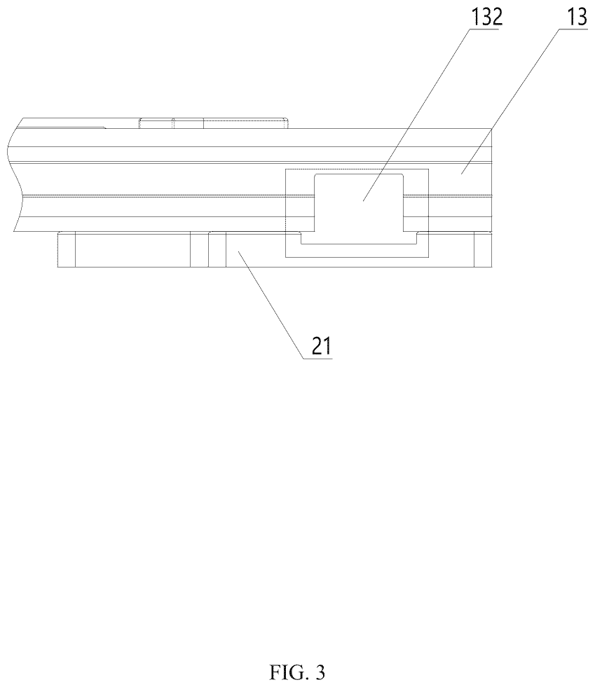

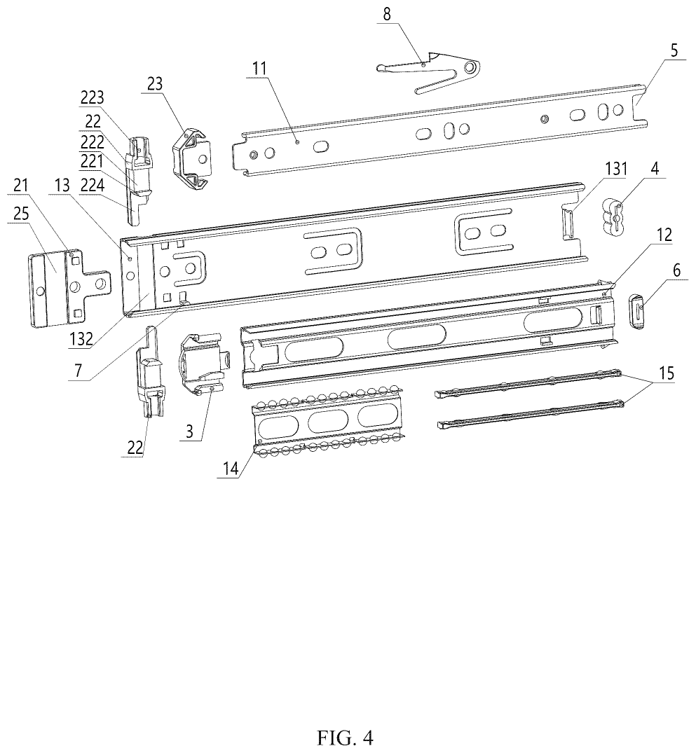

According to FIGS. 1 to 5, a convenient guide rail interlocking mechanism of the present disclosure includes an interlocking mechanism configured to lock or unlock a plurality sets of guide rail components 1 that are distributed in upper and lower. The guide rail components 1 include an inner rail 11, a middle rail 12, and an outer rail 13 that are slidably connected. An inner pearl nest component 14 is slidably provided between the middle rail 12 and the inner rail 11, an outer bead nest assembly 15 is slidably provided between the middle rail 12 and the outer rail 13. Where, the interlocking mechanism includes a front-end interlocking assembly 2, which includes a front lock fixing seat 21, a front lock insertion block 22, a front lock clamp block 23, and a linkage rod 24. The front lock fixing seat 21 is installed at a front end of the outer rail 13, and is provided with a guide recess 25. Two ends of the linkage rod 24 are respectively provided with the front lock insertion block 22, which is inserted into a corresponding outer rail 13. At the same time, the front lock insertion block 22 is slid downward on the guide recess 25 under its own weight, and under a linkage action of the linkage rod 24, a lower front lock insertion block 22 is moved downward and locked on a corresponding lower outer rail 13. The front lock clamp block 23 is installed at a front end of the inner rail 11, and the front lock clamp block 23 pushes the front lock insertion block 22 to move upward when the inner rail 11 is slide outward, so that the front lock insertion block 22 is opened and unlocked on the outer rail 13. At the same time, under the linkage action of the linkage rod 24, an upper front lock insertion block 22 is driven to be locked on a corresponding upper outer rail 13.

In a practical application, the outer rail 13 is provided with a connection guide slot 131 and a plug-in slot 132; upper and lower sides of the outer rail 13 are respectively provided with the plug-in slot 132; the front lock insertion block 22 is inserted into the outer rail 13 through the plug-in slot 132. The front lock fixing seat 21 can be disassembled and installed on an outside of the outer rail 13 through a connector, so that the guide recess 25 is communicated with the connection guide slot 131 and forms a front-end interlocking groove for the front lock insertion block 22 to be locked or unlocked on the outer rail 13.

During assembly, the front lock fixing seat 21 is installed at a front end of the outer rail 13, and then the front lock insertion block 22 is inserted into the upper and lower sides of the outer rail 13 through the plug-in slot 132, which can slide freely in the front-end interlocking groove. Meanwhile, the outer bead nest assembly 15 and the inner pearl nest component 14 are configured to be a steel frame for fixing steel balls, which can freely roll in slots between the inner rail 11, the middle rail 12, and the outer rail 13, this facilitates assembly and production.

Where, the front lock insertion block 22 includes a front locking protrusion 221 that slides in the guide recess 25 and be locked or unlocked at the front end of the outer rail 13. The front locking protrusion 221 is provided with a limit groove 222 so as to prevent the front locking protrusion 221 form being detached from the outer rail 13.

In an implementation mode, an outer end of the front lock insertion block 22 is provided with a clamp slot 223 configured for the linkage rod 24 to be inserted, an inner end of the front lock insertion block 22 is provided with an extended linkage push rod 224. The front lock insertion blocks 22 that are distributed in upper and lower are inserted into the outer rail 13, and extended linkage push rods 224 between the front lock insertion blocks 22 are connected or separated in a staggered manner.

In this way, through a structural cooperation of the front lock fixing seat 21, the front lock insertion block 22, the front lock clamp block 23, and the linkage rod 24 of the front-end interlocking assembly 2, not only can only one drawer be pulled out at one time under the interlocking effect, but also the interlocking function between the guide rail components 1 is achieved. And the front-end assembly is installed at the front end of the guide rail components 1 so as to solve a problem of assembly difficulty, thereby improving structural reliability, and ensuring the interlocking effect.

Referring to FIGS. 1 to 3, in an implementation mode, the front-end interlocking assembly 2 further includes a linkage self-locking component. The linkage self-locking component includes a self-locking front stopper 3 and a self-locking rear stopper rubber 4. The self-locking front stopper 3 is installed at a front end of the middle rail 12; the self-locking front stopper 3 is connected or separated from the inner rail 11 when the guide rail component 1 is opened or closed. The self-locking rear stopper rubber 4 is installed at a tail end of the outer rail 13, and the inner rail 11 is provided with a closing position 5 for elastic clamping with the self-locking rear stopper rubber 4 when the inner rail 11 is closed.

Where, a tail end of the outer rail 13 is provided with a positioning buckle 131, and the self-locking rear stopper rubber 4 is fastened to the positioning buckle 131, an outer edge of the self-locking rear stopper rubber 4 is provided with an elastic arc-shaped outer edge for elastic clamping with the closing position 5.

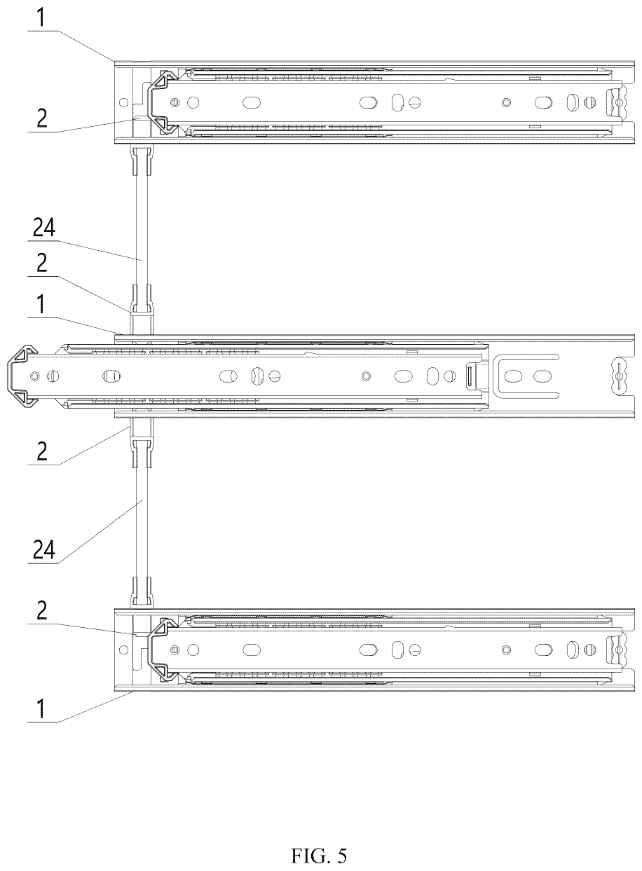

That is to say, taking FIG. 5 as an example, when a first set of guide rail components 1, a second set of guide rail components 1, and a third set of guide rail components 1 that are distributed in upper and lower are respectively in their original closed states, due to the self-weight, front lock insertion blocks 22 of each set of guide rail component 1 are moved freely downward in the front-end interlocking groove. The front lock insertion block 22 of the first set of guide rail component 1 is unlocked on the corresponding outer rail 13, thereby achieving a normal opening of the first set of guide rail component 1. The front lock insertion blocks 22 of the other two sets of guide rail components 1 are respectively locked on the corresponding outer rail 13 so as to block the corresponding inner rail 11 from being pulled out, thereby achieving locking of the second set of guide rail component 1 and the third set of guide rail component 1.

When the inner rail 11 of the second set of guide rail component 1 is pulled out, under an action of the self-locking rear stopper rubber 4, the middle rail 12 is synchronously pulled out. Then, the front lock clamp block 23 installed at the front end of the inner rail 11 pushes to open the corresponding front lock insertion block 22, the corresponding front lock insertion block 22 is caused to move upward in the front-end interlocking groove, so as to facilitate the inner rail 11 to be pulled out, thereby achieving an unlocking state of the second set of guide rail component 1 and normal opening and use. During this period, under the linkage action of the linkage rod, an upper front lock insertion block 22 is moved upward along the upper front-end interlocking groove, so that the upper front lock insertion block 22 is locked in the upper outer rail 13 so as to block the upper inner rail 11 from being pulled out, thereby achieving the first set of guide rail component 1 in a locked state and the third set of guide rail component 1 always in the locked state. Similarly, when the middle rail 12 of the third set of guide rail component 1 is pulled out, under the linkage action of the linkage rod, the upper front lock insertion block 22 is moved upward and locked in the corresponding front-end interlocking groove, thereby achieving the locked state of the first set of guide rail component 1 and the second set of guide rail component 1. Under the interlocking effect, only one drawer can be pulled out at one time so as to ensure safe use.

It is worth noting that this structure is not limited to three-layer guide rail component 1, and can also be applied to two-layer guide rail component 1 or a guide rail component 1 with two or more layers.

Referring to FIGS. 1 to 5, in an implementation mode, a rear stopper rubber 6 is provided at a tail end of the middle rail 12 for stopping the inner pearl nest component 14 from moving backward or synchronously moving forward with the inner rail 11. The rear stopper rubber 6 is clamped in or separated from the closing position 5 when the middle rail 12 is moved, an internal limit movement space for a movement of the inner pearl nest component 14 is formed between the rear stopper rubber 6 and the self-locking front stopper 3.

During this period, a tail end of the inner rail 11 is provided with a rubber stopper 8 for pushing the inner pearl nest component 14 to move. When the inner rail 11 is in a closing position, a shortest distance between the rubber stopper 8 and the self-locking front stopper 3 is a pull-out distance L1 of the inner rail 11 relative to the middle rail 12.

In an implementation mode, two sides of a front end of the outer rail 13 are provided with a front stop point 7, an outer limit movement space for a movement of the outer bead nest assembly 15 is formed between the front stop point 7 and the self-locking rear stopper rubber 4. Meanwhile, a maximum distance between the front stop point 7 and the self-locking rear stopper rubber 4 minus a length of the outer bead nest assembly 15 is a pull-out distance L2 of the middle rail 12 relative to the outer rail 13. In this way, a sum of the pull-out distance L1 and the pull-out distance L2 is the pull-out distance L of the inner rail 11 relative to the outer rail 13, which is a pull-out distance of the guide rail component 1 itself.

That is, the interlocking component of this structure simplifies the assembly of the guide rail component 1 of the present disclosure, free opening and closing degree of the guide rail component 1 are further improved and facilitate its use. Besides, the self-locking front stopper 3 of the self-locking component is used to limit a backward travel of the middle rail 12, and it can also cooperate with the closing position 5 of the inner rail 11 so as to achieve the self-locking function, avoiding an inability of the guide rail component 1 in the unlocking state to slide out freely.

The above specific embodiments are only embodiments of the present disclosure, and any structure that is the same or equivalent to the convenient rail interlocking mechanism of the present disclosure is within the protection scope of the present disclosure.

What is claimed is:

1. A convenient guide rail interlocking mechanism, comprising an interlocking mechanism configured to lock or unlock a plurality sets of guide rail components,
wherein the guide rail components comprise an inner rail, a middle rail, and an outer rail that are slidably connected;
an inner pearl nest component is slidably provided between the middle rail and the inner rail, an outer bead nest assembly is slidably provided between the middle rail and the outer rail,
wherein the interlocking mechanism comprises a front-end interlocking assembly, the front-end interlocking assembly comprises a front lock fixing seat, a front lock insertion block, a front lock clamp block, and a linkage rod;
the front lock fixing seat is provided at a front end of the outer rail; the front lock fixing seat is provided with a guide recess;
two ends of the linkage rod are respectively provided with the front lock insertion block, and the front lock insertion blocks are respectively inserted into a corresponding outer rail;
the front lock insertion block is slid downwards on the guide recess under its own weight, and under a linkage action of the linkage rod, the front lock insertion block is driven to move downwards and locked on the corresponding outer rail;
the front lock clamp block is provided at a front end of the inner rail, and the front lock clamp block pushes the front lock insertion block to move upwards when the inner rail is slid outwards, thereby causing the front lock insertion block to be opened and unlocked on the outer rail, and at the same time, under the linkage action of the linkage rod, the front lock insertion block is driven to be locked on the corresponding outer rail.

2. The convenient guide rail interlocking mechanism according to claim 1, wherein the outer rail is provided with a connection guide slot and a plug-in slot;
upper and lower sides of the outer rail are respectively provided with the plug-in slot, and the front lock insertion block is inserted into the outer rail through the plug-in slot;
the front lock fixing seat is capable of being disassembled on an outside of the outer rail through a connector, so that the guide recess is communicated with the connection guide slot and forms a front-end interlocking groove for the front lock insertion block to be locked or unlocked on the outer rail.

3. The convenient guide rail interlocking mechanism according to claim 1, wherein the front lock insertion block comprises a front locking protrusion that slides in the guide recess and be locked or unlocked at the front end of the outer rail;
the front locking protrusion is provided with a limit groove so as to prevent the front locking protrusion from being detached from the outer rail.

4. The convenient guide rail interlocking mechanism according to claim 1, wherein an outer end of the front lock insertion block is provided with a clamp slot for the linkage rod to be inserted, an inner end of the front lock insertion block is provided with an extended linkage push rod;
the front lock insertion block is capable of being inserted into the outer rail, so that extended linkage push rods between the front lock insertion blocks are connected or separated in a staggered manner.

5. The convenient guide rail interlocking mechanism according to claim 1, wherein the front-end interlocking assembly further comprises a linkage self-locking component, which comprises a self-locking front stopper and a self-locking rear stopper rubber;
the self-locking front stopper is provided at a front end of the middle rail, and the self-locking front stopper is connected or separated from the inner rail when the guide rail components is opened or closed;
the self-locking rear stopper rubber is provided at a tail end of the outer rail, and the inner rail is provided with a closing position for elastic clamping with the self-locking rear stopper rubber when the inner rail is closed.

6. The convenient guide rail interlocking mechanism according to claim 5, wherein a tail end of the outer rail is provided with a positioning buckle, the self-locking rear stopper rubber is capable of being fastened to the positioning buckle, an outer edge of the self-locking rear stopper rubber is provided with an elastic arc-shaped outer edge that is elastically clamped with the closing position.

7. The convenient guide rail interlocking mechanism according to claim 5, wherein a tail end of the middle rail is provided with a rear stopper rubber for stopping the inner pearl nest component from moving backward or synchronously moving forward with the inner rail;
the rear stopper rubber is clamped in the closing position or separated from the closing position when the middle rail is moved;
an internal limit movement space for a movement of the inner pearl nest component is formed between the rear stopper rubber and the self-locking front stopper.

8. The convenient guide rail interlocking mechanism according to claim 5, wherein two sides of a front end of the outer rail are respectively provided with a front stop point;
an outer limit movement space for a movement of the outer bead nest assembly is formed between the front stop point and the self-locking rear stopper rubber.

9. The convenient guide rail interlocking mechanism according to claim 1, wherein a tail end of the inner rail is provided with a rubber stopper configured to push the inner pearl nest component to move;
a shortest distance between the rubber stopper and the self-locking front stopper is a pull-out distance of the inner rail relative to the middle rail.
